(19) United States
(12) Patent Application Publication
(10) Pub. No.: US 2014/0253323 A1
(43) Pub. Date: Sep. 11, 2014

(54) LOW ANALYTE LEVEL ALERT SYSTEM FROM CONTINUOUS ANALYTE MONITOR

(71) Applicant: LifeScan, Inc., Milpitas, CA (US)

(72) Inventor: Shawn Berven, Philadelphia, PA (US)

(73) Assignee: LifeScan, Inc.

(21) Appl. No.: 13/787,268

(22) Filed: Mar. 6, 2013

(51) Int. Cl. G08B 21/02

(52) U.S. Cl. CPC G08B 21/02
USPC 340/539.12

(57) ABSTRACT

Described are embodiments of a system or method configured to emit an alert indicator in response to detecting an anomalous analyte event in a patient wearing a continuous analyte monitor. Absent a response from the patient to the alert indicator, the system or method escalates the alert notifications by communicating alert messages to other alarm devices or to caregivers that may be needed to assist the patient.

### TECHNICAL FIELD

This application generally relates to the field of continuous blood glucose measurement devices that transmit alerts indicating that a glycemic condition is detected that exceeds a preset threshold and, more specifically, to notification systems coupled to the continuous blood glucose measurement devices for progressively alerting one or more remote devices or persons of the hypoglycemic condition.

### BACKGROUND

Continuous blood glucose monitors are used for testing an individual's blood on a continuous basis so long as the monitor is worn. The monitor is worn by the user and includes a glucose sensor that is inserted subcutaneously and remains in place until it's exchanged with a new sensor. The glucose sensor may measure glucose levels at predetermined intervals (e.g., every few minutes). A transmitter connected to the contained sensor is used to communicate glucose measurement information to an electronic receiver carried by the user and which displays the measured glucose levels. The receiver may display the measured blood glucose levels in a variety of formats, such as alphanumerically or graphically.

Because these glucose monitors are portable, patients are able to use such devices in the normal course of their daily lives without significant interruption to their personal routines. Therefore, a person with diabetes may monitor their blood glucose levels as a part of a self management process to ensure proper control of their blood glucose. These systems are designed to warn the user if glycemic excursions occur in excess of a target range. The warning indicators, or alert indicators, produced by the monitor may include audible tones, visible light displays, or a vibrating alert. If the user is in a noisy environment, or otherwise distracted, the alert indicators may not be noticed. An alert indicator may also be missed if the user is affected by, for example, a hypoglycemic condition such as becoming disoriented or unconscious. In such instances, the glycemic excursion can become serious and lead to seizure, or loss of consciousness. In the long term, failure to maintain target glycemic control can result in serious diabetes-related complications including cardiovascular disease, kidney disease, nerve damage and/or blindness.

### SUMMARY OF THE DISCLOSURE

Therefore, and according to a first aspect, applicant has devised an analyte level management method that includes, but is not limited to, handling an alert signal transmitted by an analyte monitor worn by a person, the method includes emitting an alert indicator of an anomalous analyte level. After a predetermined time period, an alert signal is transmitted to another notification device if there is no acknowledgment received in response to the alert indicator. The notification device then initiates a progressive notification sequence including transmitting a first command signal to at least a first reception device which causes it to emit a physical signal, i.e., another alert indicator indicative of the anomalous analyte level. This sequence can continue based on tolling of predetermined time intervals progressively to other reception devices that are either those of the person wearing the monitor or designated caregiver(s). The notification sequence is terminated in response to an acknowledgment signal received at the notification device from any communication device contacted during the notification sequence.

According to another aspect, an analyte measurement system is disclosed which includes a continuous analyte monitor having a detection circuit for detecting an analyte level of a person wearing the continuous analyte monitor. A communication circuit in the monitor transmits an alert signal if the detection circuit detects an analyte level exceeding a preset threshold. A processing unit, which may be disposed in another communication device, receives the alert signal and initiates a programmed notification sequence in response thereto. The processing unit transmits a command signal to a plurality of reception devices according to a progressive transmission sequence based on the tolling of predetermined time intervals or otherwise based on the severity of the alert message and the failure to receive an acknowledgement of the alert message. The sequence is terminated by an acknowledgement signal received at the processing unit from any one of the reception devices, by either the person wearing the monitor or assigned caregiver(s).

In accordance with yet another aspect, an alert notification protocol is used in conjunction with a medical monitoring device and a notification device. The monitoring device is worn by a person and is configured to detect at least one anomalous medical condition of the person based on a detected reading and emitting an alert signal in response thereto. The notification device includes a processor programmed to receive the alert signal. According to the protocol, the monitoring device emits a first physical signal indicative of the anomalous medical condition followed by a first predetermined time period. If no acknowledgement of the first physical signal is received during the time period, the alert signal is then transmitted to the notification device. The notification device then emits a second physical signal in response to the alert signal followed by a second predetermined time period. If no acknowledgement of the second physical signal is received during the second time period the notification device transmits an alert signal to at least one other separate device proximate to the subject or proximate to at least one designated caregiver in a progressive manner. The notification protocol is not terminated until an acknowledgement is received by the notification device.

According to one version, the notification device is a smart phone or similar device having a processor and communication circuit for carrying out the progressive alert protocol.

Advantages that may be realized in several embodiments described herein, are that users on continuous glucose monitoring receive alerts on their monitors and, in addition, can be alerted using several back-up devices. An integrated, multi-device progressive alert system ensures that users receive alerts from multiple devices when they are experiencing a hypoglycemic event. Furthermore, if the user does not acknowledge an alert from any of these devices, then caregivers of the user receive alerts in an escalating notification sequence to make certain that the user receives proper attention.

In the aforementioned aspects of the disclosure, the steps disclosed may be performed by an electronic circuit or a processor to provide for a technical effect in the art. These steps may also be implemented as executable instructions stored on a computer readable medium; the instructions, when executed by a computer may perform the steps of any one of the aforementioned methods.

These and other embodiments, features and advantages will become apparent to those skilled in the art when taken with reference to the following more detailed modes of carrying out the invention in conjunction with the accompanying drawings that are first briefly described.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention (wherein like numerals represent like elements).

FIG. 1 illustrates a receiving device of an exemplary continuous glucose monitor;

FIG. 2 illustrates a circuit diagram of an exemplary communication device described herein;

FIG. 3 illustrates an exemplary glucose monitoring system; and

FIG. 4 illustrates a flow chart of an exemplary alert protocol for the blood glucose monitoring system of FIG. 3.

### DETAILED DESCRIPTION

The following Detailed Description should be read with reference to the drawings, in which like elements in different drawings are identically numbered. The drawings, which are not necessarily to scale, depict selected embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. The following embodiments relate specifically to alert protocols for a blood glucose measurement system, but it will be readily apparent that the functionalities described are equally applicable to other forms of analyte or physiological parameter measurement systems, such as worn medical monitors and holters, such as those used for periodically or continually measuring patient vital signs.

As used herein, the terms “patient” or “user” refer to any human or animal subject and are not intended to limit the systems or methods to human use, although use of the subject invention in a human patient represents a preferred embodiment.

The term “caregiver”, as used herein, relates to any person that may in some way manage the patient's condition, or help them manage it. For example, caregivers can refer to anyone designated to care for a person or help them care for themselves, such as relatives, nurses, teachers, co-workers, and the like.

Continuous glucose monitors measure a glucose level using a subcutaneous sensor. If the level of glucose detected exceeds a preset selectable threshold, e.g., outside of a safe target range, an electric circuit in the glucose monitor may be programmed to respond to the detected unsafe level with any of a variety of alarm outputs. For example, a tone may be emitted by a speaker, a light source, such as an LED, may emit a visual signal, a vibratory mechanism may be activated, or a text message may be displayed on a display of the glucose monitor, or any combination of these physical alarm or alert signals may be implemented by the monitor. If a user experiences a hypoglycemic condition, a corresponding alert indicator may not be perceived due to a noisy environment, or because the user is distracted or incapacitated, such as by becoming disoriented, losing cognitive ability, or losing consciousness due to the hypoglycemic event.

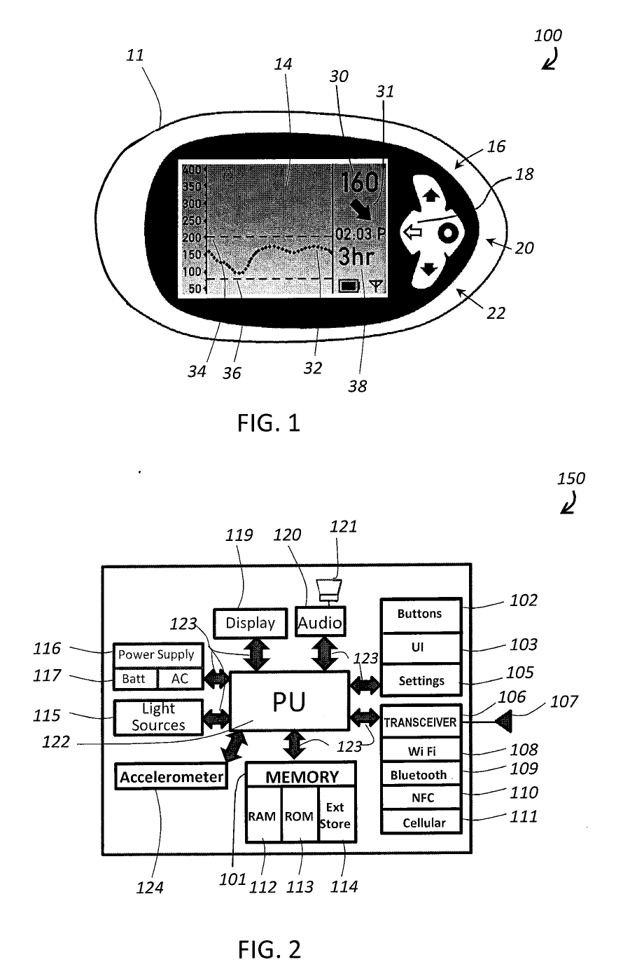

FIG. 1 illustrates a portion of a continuous glucose monitor (“CGM”) comprising a glucose measurement receiver 100. Another portion of the CGM includes a glucose sensor worn by the user which is implanted subcutaneously and connected to a radio frequency (“RF”) wireless transmitter for communicating glucose measurement information to the glucose measurement receiver 100 which is carried, but may also be worn, by the user. An example of an exemplary monitor is described in U.S. Pat. No. 7,276,029, which is incorporated by reference herein as if fully set forth herein this application. In one embodiment, a continuous glucose sensor from the Dexcom Seven System (manufactured by Dexcom Inc.) can also be utilized with the exemplary embodiments described herein. The glucose measurement receiver 100 is defined by a housing 11 that includes an interior sized to retain a plurality of components. Among these components is a display 14, such as an LCD, that displays the measured blood glucose levels in a practically continuous manner. The housing 11 retains a data management unit (“DMU”) 150 (FIG. 2) that includes a plurality of user interface buttons 16, 18, 20, and 22 disposed on the exterior of the housing. The plurality of user interface buttons 16, 18, 20, and 22 can be configured to allow the entry of data, to prompt an output of data, to navigate menus presented on the display 14, and to execute commands. Output data can include values representative of blood glucose levels presented on the display 14, such as a current blood glucose reading 30, a graph of the most recent past readings 32, a trend indicator 31, size of the time window 38, as well as maximum 34 and minimum 36 target glucose levels that define a target glucose range. Other display icons may be included, such as a standard type battery power level indicator, as well as those indicative of time of day, and wireless RF reception strength, among others. Input information, which is related to the everyday lifestyle of an individual, can include food intake, medication use, occurrence of health check-ups, and general health condition and exercise levels. These inputs can be requested via prompts presented on the display 14 and can be stored in a memory module 101, FIG. 2 of the glucose measurement receiver 100. Specifically and according to this exemplary embodiment, the user interface buttons 16, 18, 20, and 22 include markings, such as arrows and/or a circle, to allow a user to navigate through user interfaces and menus presented on the display 14 such as by scrolling, selecting input menus, and entering selections. The interface buttons 16, 18, 20 and 22 may be mechanical/electrical switches; however, a touch screen interface with virtual buttons may also be utilized. Although a continuous glucose monitor system has been described herein, a blood glucose meter using glucose test strips for performing blood glucose measurements can also be utilized as an alternative to the embodiments described herein.

The electronic components of the glucose measurement receiver 100 can be disposed on, for example, a printed circuit board situated within the housing 11 and forming the DMU 150 of the glucose measurement receiver 100 described herein. FIG. 2 illustrates, in simplified schematic form, several of the electronic components disposed within the housing 11 for purposes of this embodiment. The DMU 150 includes a processing unit 122 in the form of a microprocessor, a microcontroller, an application specific integrated circuit (“ASIC”), a mixed signal processor (“MSP”), a field programmable gate array (“FPGA”), or a combination thereof, and is electrically connected to various electronic modules included on, or connected to, the printed circuit board, as will be described below. The processing unit 122 is electrically connected to, for example, a transceiver 106 over a communication line 123, the transceiver being connected to an antenna 107 which receives the aforementioned transmitted glucose measurement information from the glucose sensor.

A display module 119, which may include a display processor and display buffer, is electrically connected to the processing unit 122 over the communication line 123 for receiving and displaying output data as described above, and for displaying user interface input options under control of processing unit 122. The structure of the user interface, such as menu options, is stored in user interface module 103 and is accessible by the processing unit 122 for presenting menu options to a user of the glucose measurement receiver 100. An audio module 120 includes a speaker 121 for outputting audio data received or stored by the DMU 150. Audio outputs can include, for example, notifications, reminders, tones, and alarms, or may include audio data to be replayed in conjunction with display data presented on the display 14. For example, stored audio data may include voice data which, when replayed over speaker 121, can be heard by the user and may include helpful instructions, alerts, or other information. Such stored audio data can be accessed by the processing unit 122 and executed as playback data at appropriate times. A volume of the audio output is controlled by the processing unit 122 under programmed control, and the volume setting can be stored in settings module 105, as determined by the processor or as adjusted by the user. One of the algorithms included in a volume control program may be a procedure for increasing a volume of an audible alert indicator up to a maximum volume of the included speaker or until a programmed alert period expires. Although not shown, the audio module 120 may be connected to a motor for outputting alerts, alarms, or reminders in the form of a vibratory output or to otherwise notify the user during times when the audio is turned off. User input module 102 receives inputs via user interface buttons 16, 18, 20, and 22 which are received and transmitted to the processing unit 122 over the communication line 123. Although not shown in FIG. 2, the processing unit 122 has electrical access to a digital time-of-day clock connected to the printed circuit board for recording dates and times of periodic glucose measurements received from the glucose sensor, which may then be accessed, uploaded, or displayed as necessary. Associated with the clock is a timer for recording elapsed times, preset or predetermined time delays under programmed control of the processing unit 122.

The display 14 can alternatively include a backlight and the brightness of the display backlight may be controlled by the processing unit 122 via a light source control module 115. Similarly, the user interface buttons 16, 18, 20, and 22 may also be illuminated using LED light sources electrically connected to processing unit 122 for controlling a light output of the buttons. The light source module 115 is electrically connected to the display backlight and processing unit 122. Default brightness settings of all light sources, as well as settings adjusted by the user, are stored in a settings module 105, which is accessible and modifiable by the processing unit 122. The processing unit 122 may also control an intensity of the light output in a programmed manner similar to the audio volume control algorithms described above.

A memory module 101, that includes but is not limited to volatile random access memory (“RAM”) 112, a non-volatile memory 113, which may comprise read only memory (“ROM”) or flash memory, and a circuit 114 for connecting to an external portable memory device port, is electrically connected to the processing unit 122 over a communication line 123. External memory devices may include flash memory devices housed in thumb drives, portable hard disk drives, data cards, or any other form of electronic storage devices. The on-board memory can include various embedded and default applications executed by the processing unit 122 for operation of the glucose measurement receiver 100, as will be explained below. On board memory can also be used to store a history of a user's glucose measurements including dates and times associated therewith which may be displayed as illustrated in FIG. 1. Using the wireless transmission capability of the glucose measurement receiver 100, as described below, such measurement data can be transferred via wired or wireless transmission to connected computers or other processing devices.

A wireless module 106 may include transceiver circuits for wireless digital data transmission and reception via one or more internal digital antennas 107, and is electrically connected to the processing unit 122 over communication line 123. The wireless transceiver circuits may be in the form of integrated circuit chips, chipsets, programmable functions operable via processing unit 122, or a combination thereof. Each of the wireless transceiver circuits is compatible with a different wireless transmission standard. For example, a wireless transceiver circuit 108 may be compatible with the Wireless Local Area Network IEEE 802.11 standard known as WiFi. Transceiver circuit 108 is configured to detect a WiFi access point in proximity to the glucose measurement receiver 100 and to transmit and receive data from such a detected WiFi access point. A wireless transceiver circuit 109 may be compatible with the Bluetooth protocol and is used by the processing unit 122 to detect and synchronize with BlueTooth compatible devices in proximity to the continuous glucose measurement receiver 100. The user may choose to synchronize the glucose measurement receiver 100 with a cell phone, a tablet computer, or other computing device, thereby automatically establishing a Bluetooth communication channel, or other RF wireless communication channel, between the continuous glucose measurement receiver 100 and one or more other computing devices when they are within range of each other. The wireless transceiver circuit 109 may also be configured to receive and process data transmitted over a preselected communication channel from the glucose sensor worn by the user, which channel may include a Bluetooth communication channel if the sensor includes a BlueTooth capability. A wireless transceiver circuit 110 may be compatible with the near field communication (“NFC”) standard and is configured to establish radio communication with, for example, any NFC compliant device in proximity to the glucose measurement receiver 100. A wireless transceiver circuit 111 may comprise a circuit for cellular communication with cellular networks and is configured to detect and link to available cellular communication towers.

A power supply module 116 is electrically connected to all modules in the housing 11 and to the processing unit 122 to supply electric power thereto. The power supply module 116 may comprise standard or rechargeable batteries or an AC power supply 117 may be activated when the glucose measurement receiver 100 is connected to a source of AC power. The power supply module 116 is also electrically connected to the processing unit 122 over the communication line 123 such that processing unit 122 can monitor a power level remaining in a battery power mode of the power supply module 116. Although the DMU 150 has been described herein insofar as it is used within glucose measurement receiver 100, it should be noted that similar functions using similar circuitry may also be provided in the various communication devices described herein, such as cellular phones, such as smart phones, tablet computers and other communication devices, described below, containing processing systems.

The glucose measurement receiver 100 may also include at least one position sensor, such as an accelerometer 124 electrically connected to the processing unit 122, which is capable of indicating a severe change in attitude in the monitor. This change in attitude could be representative of a more serious condition of the user; e.g., that the user has possibly collapsed due to a hypoglycemic event. Another indication from the accelerometer may result in determining that the monitor is not in motion, or has not been in motion for a period of time, and therefore that the user may not capable of responding to an alert indicator. Thus, the processing unit 122 of the glucose measurement receiver 100 may use such indications from the accelerometer 124 to determine a severity of the alert condition.

In terms of operation, one aspect of glucose measurement receiver 100 includes a capability for automatically detecting a glucose excursion outside of the target range as entered and stored by the user in the glucose measurement receiver 100. For example, a user of glucose measurement receiver 100 may enter minimum and maximum glucose values, 36, 34, respectively, that are stored in the memory of glucose measurement receiver 100 and are displayed on display screen 14 as illustrated in FIG. 1.

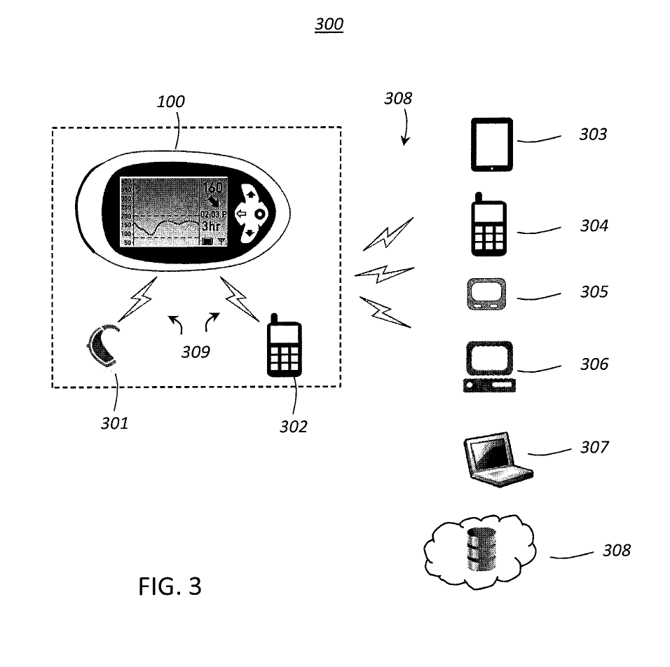

With reference to FIG. 3, there is illustrated an exemplary portion of a continuous glucose monitoring system 300. The system 300 includes the glucose measurement receiver 100, communication devices belonging to the user, such as a smart hearing aid 301 and smart phone 302, as examples. Remote communication devices which may belong to caregivers of the user include a tablet computer 303, a cellular phone or smart phone 304, a pager 305, a personal computer 306, and a laptop computer 307, all of which may receive electronic communication signals transmitted by the glucose measurement receiver 100 or smart phone 302, over a wireless communication channel 308, and may transmit an acknowledgment signal back to the glucose measurement receiver 100 or smart phone 302 over wireless communication channel 308 in response. The wireless communication channel may also provide access to the internet to allow alert signals or messages to be transmitted to internet connected computing devices. Thus, the WiFi or cellular capability of glucose measurement receiver 100 may be used to communicate to internet connected computing devices, which may include a PC 306, laptop 307, or an internet server 308. Any of the remote communication devices 303-307 may be interchangeable with the communication devices belonging to the user, 301-302, without diminishing the advantageous features of the continuous glucose monitoring system described herein. Upon detecting, for example, a hypoglycemic condition, wherein the glucose sensor detects and transmits a glucose measurement to glucose measurement receiver 100 that falls below the preselected stored minimum glucose level, the processing unit 122 activates an alert indicator in the glucose measurement receiver 100 for notifying the user that his or her glucose level is low. This may result in the processing unit 122 activating the audio module, the display module, the light source module, or the vibration motor, or a combination thereof, to activate any of these physically perceivable alert indicators. The user will typically acknowledge such an alert indicator by pressing one of the buttons 16, 18, 20, or 22, which serves to acknowledge and terminate the alert. If the user does not take appropriate corrective measures to alleviate the hypoglycemic condition, the glucose measurement receiver 100 may be programmed to issue another alert at the next glucose measurement interval until the measured glucose level is actually back brought within the target range. If the user does not respond to the glucose measurement receiver's 100 alert indicator within a preset delay time, as preselected and stored in the glucose measurement receiver 100, the processing unit 122 is programmed to transmit an electronic alert signal, or a command, over a wireless channel 309, such as a Bluetooth communication channel automatically established between the continuous glucose measurement receiver 100 and the user selected communication device, such as a smart phone 302, or other communication device as described herein.

In response to the electronic alert signal, an alert notification sequence is initiated in the user selected communication device, such as smart phone 302, hereinafter referred to as the “notification device”. Thus, in one aspect, the user has loaded and set up an appropriate program in the selected computing device which recognizes the alert signal as originating from the user's glucose measurement receiver 100 and automatically activates a notification sequence previously set up by the user or caregiver. The notification sequence involves a series of escalating alert protocols for notifying other devices that may communicate alert indications to the user or notify communication devices carried by caregivers if the user does not acknowledge the alert indicators. Thus, as part of the set up routine, the user may preselect a sequence of devices that are to be progressively notified of the alert condition, including devices owned and typically carried by the user 301, 302, or which the user is habitually in close proximity to such as a personal desktop computer, and devices owned or carried by caregivers of the user, 303-307. The devices may include any electronic communication devices that are capable of receiving an alert signal, or a command, transmitted over a wireless RF channel addressed to the device and responding thereto by emitting a visual, audible, or vibratory indicator, which may include cellular smart phones, tablet computers, pagers, smart hearing aids, beepers, and the like. In such a programmed sequence, if an acknowledgment is not received at the continuous glucose measurement receiver 100 or another notification from the user in response to the initial alert indication, the notification sequence progressively and sequentially notifies other communication devices associated with the user or the user's caregivers until an acknowledgment is received, which acknowledgment serves to terminate the notification sequence and any further alert transmissions to other communication devices. The acknowledgment may be activated by the user or assigned caregivers in the notification sequence by responding to a respective communication device, such as by pressing a key or a button on the communication device, which will transmit an acknowledgment back to the notification device and terminate the notification sequence. The notification sequence may include an electronic alert signal, or command, including a text message which, when a response thereto is received, may constitute the necessary acknowledgment.

In one embodiment, the notification sequence is a programmed sequence of notification steps that involves sending electronic alert messages by a notification device to a series of devices individually, i.e., one at a time, or in combination, and which sequence is terminated if an acknowledgment is received at the notification device from any device in the series. A sequential list of devices may be electronically stored in the glucose measurement receiver 100 and transmitted to the notification device, or the list may be prepared for, entered and stored in the notification device. In another embodiment, the glucose measurement receiver 100 operates as the notification device. The communication device list may be selectively configured to include any desired electronic devices, i.e., persons, to be notified by inputting electronic address information, such as email addresses of caregivers, cell phone numbers, or IP addresses of other devices that may be used to notify caregivers, or communication devices belonging to the user. Such devices may include cellular phones such as internet capable smart phones, hand held tablet computers, pagers, electronic smart hearing aids, PCs, and the like.

In one embodiment, the notification device may be a network server 308, which receives the alert signal transmitted by the continuous glucose measurement receiver 100. The server may include programming as described herein to implement the notification sequence and manage acknowledgments that may be received from communication devices included in the notification sequence and to terminate the notification sequence in response. Additionally, the server 208 may be implemented in a cloud computing infrastructure and may provide the notification sequence as a service level management offering to any device capable of accessing the internet through standard mechanisms such as a browser or an application providing browser functionality. Such a cloud computing service delivery enables convenient on-demand network access to a user wearing the CGM as described herein. The user may unilaterally provision computing capabilities, such as server time and network access as needed automatically, without requiring the user to interact with the service provider, as part of a self-service on-demand offering. The on-demand services are accessible from the communication devices described herein and may allow user-specific set up and configuration settings.

The notification sequence is initiated by the alert signal transmitted by the continuous glucose measurement receiver 100 and received at the preselected notification device. It should be noted that, as mentioned above, the glucose measurement receiver 100 may serve as the notification device. Thus, after emitting an alert indicator in response to a hypoglycemic reading by the glucose sensor and receiving no acknowledgment thereto, the glucose measurement receiver 100 may initiate the notification sequence. The notification device accesses a pre-stored list of reception devices and transmits another alert signal or command to the first listed reception device. The alert signal or command sent to the reception device may include a text message describing the alert condition, e.g. the name of the person who is experiencing the hypoglycemic event, and a request for an acknowledgment. The acknowledgment may be activated by the recipient sending a return message, or the alert message may include an automatic return acknowledgment that is activated by the recipient accessing the alert message. If the reception device is a pager, for example, the alert message on the pager may be accompanied by a tone emitted by the pager which requires that the recipient activate a button on the pager to quiet the tone. This will also activate and return an acknowledgment to the notification device. In any such instances, the acknowledgment received at the notification device terminates the notification sequence.

The stored list of reception devices may also include a predetermined delay time or response time interval corresponding to each reception device. The delay time controls the time period between alert message transmissions to succeeding devices on the list of devices. Thus, if an acknowledgment is not received from a reception device within its respective delay time, the notification device will automatically transmit the alert message to the next device in the list and similarly await an acknowledgment signal within its corresponding delay time. The notification sequence is ceased upon the notification device receiving an acknowledgment signal from any reception device in the sequence. The devices listed in the sequence may include devices that are capable of outputting physical signals such as alarm sounds, visual alarm indications, or vibrations which require the recipient to actively shut off the physical signal, thereby activating a return acknowledgment. The devices may include communication devices, such as cell phones and pagers. Thus, the list of communication devices to be sequentially notified may include respective device types and a corresponding type of notification to be transmitted to those devices. An alert message sent to a cellular phone may include a recorded voice message or a text message which may request that the listener acknowledge the alert by pressing a number on the keypad in response.

Exemplary tables of preselected identified communication devices that may be accessed by the notification device for generating and transmitting an alert signal or command is shown below. In one aspect, a measured glucose level received at glucose measurement receiver 100 may be calculated therein, according to a stored program, as exceeding the target range by minimal amount. A programmed response to this glucose measurement causes the processing unit to access a first table corresponding to “low severity”. The low severity table lists a pager as the first device in the notification sequence, which pager belongs to the user. Thus, upon accessing the table the notification device electronically transmits an alert signal or command to the ID# provided in the table for that device. The delay period for the pager indicates a five minute delay, which indicates to the processing unit that the next communication device listed in the table should receive an alert signal or command in five minutes if no acknowledgment is received at the notification device from the pager in that time. Further communication devices in the notification sequence are similarly notified. All the entries in the low severity table are entered by the user or another person, and are accessible by the user or another person for later modification.

In another aspect, a measured glucose level received at glucose measurement receiver 100 may be calculated therein, according to a stored program, as exceeding an emergency target range defined by stored minimum and maximum glucose levels that exceed the standard target range described above. As mentioned above, the monitor may include at least one position sensor, such as an accelerometer, capable of further indicating a change or lack of change in attitude in the worn monitor, which can also be used by the processing unit in terms of determining the severity of the alert. A programmed response to this glucose measurement causes the processing unit to access a second table corresponding to “high severity”. The high severity table lists a cellular phone belonging to a caregiver as the first device in the notification sequence. Thus, in this aspect, the notification device will not electronically transmit an alert signal or command to a communication device belonging to the user when the user is undergoing a severe hypoglycemic event. (As described above, in the low-severity alert condition the glucose measurement receiver 100 emits an unacknowledged alert indicator prior to initiating the notification sequence.) Instead, the notification device electronically transmits an alert signal or command to the communication device belonging to the caregiver with a one minute delay, as listed, before transmitting an alert signal or command to a communication device belonging to a next identified caregiver of the user if no acknowledgement is received from the caregiver within the one minute period. Further communication devices in the sequence may be similarly notified if entered. All the entries in the high severity table are entered by the user or another person, and are accessible by the user or another person for later modification.

Low Severity

| Device | Owner | Settings | ID |
|---|---|---|---|
| Pager | Same | 5 min delay | #xxxxxxx |
| Cellular | Nurse | txt | #xxxxxxx |
| Phone | | 5 min delay | |
| Tablet | Son | 5 min delay | zz@yy.com |
| . . . | . . . | . . . | . . . |

High Severity

| Device | Owner | Settings | ID |
|---|---|---|---|
| Cellular | Caregiver | txt | #xxxxxxx |
| Phone | | 1 min delay | |
| Tablet | Son | 1 min delay | zz@yy.com |
| . . . | . . . | . . . | . . . |

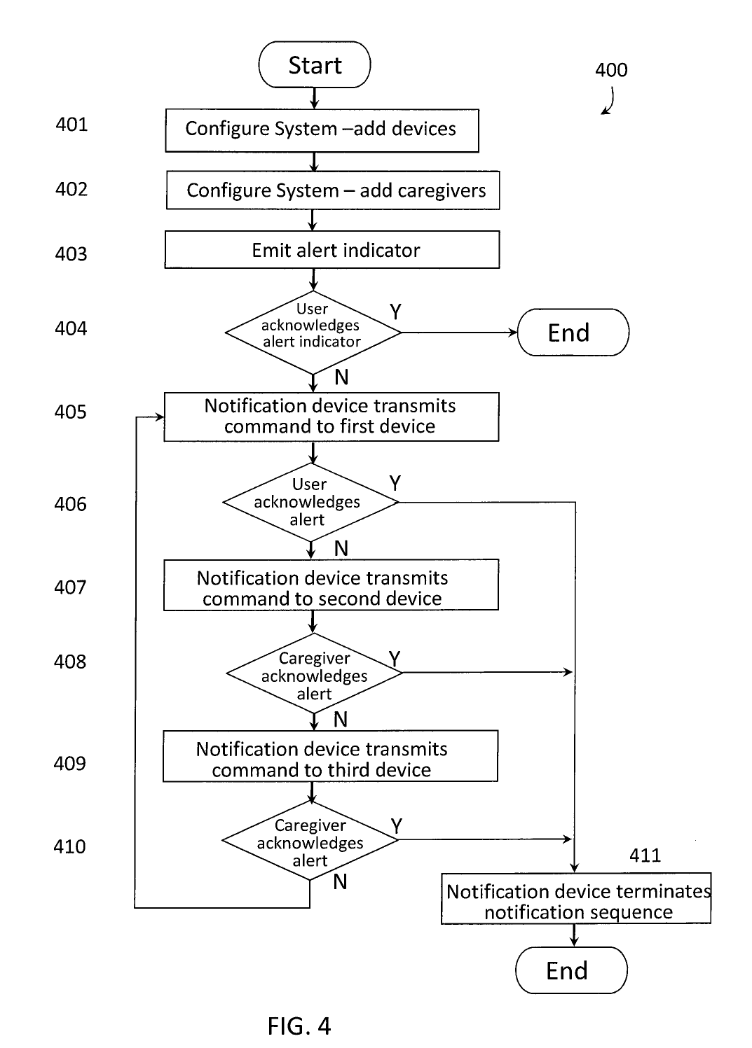

With reference to FIG. 4, there is illustrated an exemplary protocol, or programmed method, for operating the glucose monitoring system 300 that utilizes several of its features herein described. Initially, at steps 401 and 402, the notification device is configured by storing therein a list of reception devices that will include the group of communication devices forming part of the notification sequence. In particular, step 401 may include identifying and adding to the stored table communication devices owned by the user, and associated information as described above, of the glucose monitoring system 300 to directly notify the user that a hypoglycemic event has been detected. At step 402, devices and associated information as described above, used to notify caregivers are added to the stored table of notification devices. After this setup is completed, the glucose monitoring system 300 is prepared to perform functions as described herein. Thus, the glucose measurement receiver 100 may receive a transmission of a glucose measurement from the glucose sensor worn by the user, which measurement may indicate that the user's glucose level is exceeding the stored target range, such as a hypoglycemic glucose level. At step 403, an alert indicator from the continuous glucose measurement receiver 100 is emitted to notify the user that a hypoglycemic condition is detected. If, at step 404, the user acknowledges the alert indicator within a preset time period the process ends and the continuous glucose measurement receiver 100 will return to its normal monitoring state.

If, at step 404, the user does not acknowledge the alert indicator within the preset time period, the continuous glucose measurement receiver 100 transmits an alert signal to a notification device, 303-308, which, in turn, will begin the notification sequence at step 405 by sending a command to another user device (first device), such as the user's cellular phone, hearing aid, or other listed device, to activate an alert indicator in that device. If, at step 406, the user acknowledges the alert indicator on the user device within the preset time period, a return signal is transmitted to the notification device and the notification sequence terminates at step 411. If, at step 406, the user does not acknowledge the alert indicator within the preset time period, the notification device accesses the notification list to determine the next (second) communication device to be alerted, such as a communication device belonging to a caregiver. The notification device then transmits a command to the caregiver's communication device at step 407, which may be any type of device described herein, to activate an alert indicator thereon. If, at step 408, the caregiver acknowledges the alert indicator on the caregiver's device, a return signal is transmitted to the notification device and the notification sequence terminates at step 411. If, at step 408, the caregiver does not acknowledge the alert indicator within the preset time period, the notification device accesses the notification list to determine the next communication device in the list. The notification device then transmits a command to a next caregiver's communication device at step 409, which may be any type of device described herein, to activate an alert indicator thereon. If, at step 410, the next caregiver acknowledges the alert indicator on his or her device, a return signal is transmitted to the notification device and the notification sequence terminates at step 411. If, at step 410, the caregiver does not acknowledge the alert indicator, the notification device accesses the notification list to determine the next communication device in the list, or that the list of devices in the notification sequence is exhausted. If the list is exhausted, the process loops back and repeats, beginning at step 405. Alternatively, the process may loop back to step 403 wherein the alert indicator from the continuous glucose measurement receiver 100 is again emitted to notify the user that a hypoglycemic condition is detected. In another embodiment, the loop back process may re-notify caregivers in reverse order, starting with the last notified caregiver and working backward through the list of caregivers.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible, non-transitory medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Furthermore, the various methods described herein can be used to generate software codes using off-the-shelf software development tools such as, for example, Visual Studio 6.0, C or C++(and its variants), Windows 2000 Server, and SQL Server 2000. The methods, however, may be transformed into other software languages depending on the requirements and the availability of new software languages for coding the methods.

### PARTS LIST FOR FIGS. 1-4

11 housing, receiver unit
14 display
16 user interface button
18 user interface button
20 user interface button
22 user interface button
30 current reading
31 trend line
32 graph of recent readings
34 maximum level
36 minimum level
38 time window
100 glucose measurement receiver
101 memory module
102 buttons module
103 user interface module
105 DMU settings module
106 transceiver module
107 antenna
108 WiFi module
109 Bluetooth module
110 NFC module
111 Cellular module
112 RAM module
113 ROM module
114 external storage
115 light source module
116 power supply module
117 Batt/AC power supply
119 display module
120 audio module
121 speaker
122 processing unit
123 communication line
124 accelerometer
150 data management unit (DMU)
300 continuous glucose monitoring system
301 smart hearing aid
302 cellular phone
303 tablet computer
304 cellular phone
305 pager
306 personal computer
307 laptop computer
400 method of operating
401 step—configure system
402 step—configure system
403 step—emit alert indicator
404 decision step—user acknowledges alert indicator?
405 step—transmit command to first device
406 decision step—user acknowledges alert from first device?
407 step—transmit command to second device
408 decision step—caregiver acknowledges alert from second device?
409 step—transmit command to third device
410 decision step—caregiver acknowledges alert from second device?
411 step—notification device terminates notification sequence

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

What is claimed is:

1. A method of handling an alert message transmitted by an analyte monitor worn by a person, the method comprising:
emitting by said analyte monitor an alert indication of an anomalous analyte level;
transmitting an alert message to a notification device after a predetermined first time period following the alert indication by said analyte monitor; and
said notification device initiating a progressive notification sequence in response to receiving said alert message, the progressive notification sequence comprising:
transmitting a first command signal to at least a first reception device separate from said monitor, the first command signal causing the first reception device to emit a first physical signal indicative of the anomalous level; and
terminating the progressive notification sequence in response to an acknowledgment signal received at the notification device from the first reception device;
said notification device transmitting a second command signal to at least a second reception device separate from said first reception device following a predetermined second time period after the transmission of said first command signal, the second command signal causing the second reception device to emit a second physical signal indicative of said anomalous level; and
terminating the progressive notification sequence in response to an acknowledgment signal received at the notification device from the second reception device.

2. The method of claim 1 wherein the progressive notification sequence further comprises:
said notification device transmitting a third command signal to at least a third reception device separate from said first and second reception devices following a predetermined third time period after the transmission of said second command signal, the third command signal causing the third reception device to emit a third physical signal indicative of said anomalous level; and
terminating the progressive notification sequence in response to an acknowledgment signal received at the notification device from the third reception device.

3. The method of claim 1, wherein the first reception device emits said physical signal to said person and the second and subsequent reception devices emit said second and subsequent physical signals to at least one of the person wearing the monitor and at least one designated caregiver.

4. The method of claim 1, including the further step of progressively increasing the intensity of the physical signal emitted by the first and second reception devices until a maximum intensity is reached.

5. The method of claim 1, including the further step of progressively increasing the intensity of the physical signal emitted by the first and second reception devices until a preset expiration time is reached.

6. The method of claim 1, wherein the step of transmitting the alert message comprises transmitting the alert message wirelessly.

7. The method of claim 6, wherein the step of transmitting the alert message wirelessly comprises transmitting said alert message over at least one of a Bluetooth communication channel, a cellular communication channel, and a WiFi communication channel.

8. The method of claim 1, wherein the step of transmitting the first command signal comprises transmitting the first command signal wirelessly.

9. The method of claim 8, wherein the step of transmitting the first command signal wirelessly comprises transmitting said first command signal over at least one of a Bluetooth communication channel, a cellular communication channel, and a WiFi communication channel.

10. The method of claim 1, wherein the first reception device comprises at least one of a hearing aid, a pager, a tablet computer, a personal computer, a laptop, and a cellular phone.

11. The method of claim 2, further comprising storing in the notification device the predetermined time periods and electronic addresses of the first and second reception devices.

12. The method of claim 3, wherein the step of terminating includes the step of said person or said at least one designated caregiver activating a respective reception device to transmit the acknowledgement signal.

13. The method of claim 12, in which the analyte comprises glucose.

14. A system comprising:
a continuous analyte monitor comprising:
a detection circuit to detect an analyte level of a person wearing the continuous analyte monitor; and
a communication circuit to transmit an alert signal if the detection circuit detects that the detected analyte level exceeds a preset threshold; and
a processing unit to receive the alert signal and to initiate a programmed notification sequence in response thereto, the processing unit comprising a communication circuit to electronically transmit a command signal to a plurality of reception devices in a programmed transmission sequence, said notification sequence being terminated by an acknowledgement transmitted from one of the reception devices in response to the command signal received at the processing unit.

15. The system of claim 14, wherein the processing unit is disposed in a first reception device comprising at least one of a cellular phone, a tablet computer, a laptop, or other portable computing device.

16. The system of claim 15, wherein the cellular phone, the tablet computer, the laptop, or said other portable computing device is in Bluetooth communication with the analyte monitor.

17. The system of claim 15, wherein the processing unit includes a memory to store parameter settings which control a delay between each command signal transmitted to each of the plurality of reception devices.

18. The system of claim 15, wherein the plurality of reception devices is selected from the group consisting of a cell phone, a hearing aid, a tablet computer, a laptop, a pager, and combinations thereof.

19. An alert notification protocol used in conjunction with a medical monitoring device worn by a subject and a notification device, the monitoring device being configured for detecting at least one anomalous condition based on a detected reading and emitting an alert signal based thereon, the notification device being separate from said monitoring device and having a processor programmed to receive said alert signal, the protocol comprising:
emitting a first physical signal from said monitoring device;
following a first predetermined time period in which an acknowledgement to said physical signal is not provided, transmitting said alert signal to said notification device;
said notification device being configured to emit a second physical signal based on said alert signal; and
following a second predetermined time period, said notification device transmitting an alert signal to at least one other separate device proximate to the subject or proximate to at least one designated caregiver, and in which said notification protocol is not terminated until an acknowledgement is received by said notification device.

20. An alert notification protocol as recited in claim 19, wherein said notification device is at least one of a cellular phone, a laptop, a tablet computer and a wireless transmission and receiving device.

21. An alert notification protocol as recited in claim 19, wherein said medical monitoring device is a continuous analyte monitor.

22. An alert notification protocol as recited in claim 20, wherein said first and second physical signals each comprises at least one of a visual or audible signal.
